(19) United States
(12) Patent Application Publication
(10) Pub. No.: US 2008/0074474 A1
(43) Pub. Date: Mar. 27, 2008

(54) Ink-jet head

(75) Inventors: Young-Seuck Yoo, Seoul (KR); Jae-Woo Joung, Suwon-si (KR); Chang-Sung Park, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/902,321

(22) Filed: Sep. 20, 2007

(30) Foreign Application Priority Data
Sep. 27, 2006 (KR) 10-2006-0094407

(51) Int. Cl. B41J 2/045; B41J 29/38

(52) U.S. Cl. 347/70; 347/10

(57) ABSTRACT

An ink-jet head is disclosed. Using an ink-jet head which includes a nozzle, a chamber from which to supply ink to the nozzle, a restrictor which acts as a channel through which to supply the ink to the chamber, a vibrating plate covering one side of each of the chamber and the restrictor, a first actuator joined with the vibrating plate in correspondence to the location of the chamber, and a second actuator joined with the vibrating plate in correspondence to the location of the restrictor, the ability to control droplets can be improved, by allowing the control of the channel resistance of the restrictor.

### CROSS-REFERENCE TO RELATED APPLICATIONS

This application claims the benefit of Korean Patent Application No. 10-2006-0094407 filed with the Korean Intellectual Property Office on Sep. 27, 2006, the disclosure of which is incorporated herein by reference in its entirety.

### BACKGROUND

1. Technical Field

The present invention relates to an ink-jet head.

2. Description of the Related Art

With the widespread use of ink-jet techniques in the industry, the need to improve the performance of the ink-jet head is increasing. Generally, an ink-jet head for industrial use is a piezoelectric head, which includes a piezoelectric element.

A piezoelectric head consists of an actuator part which generates operating power, a channel part which supplies ink, and a nozzle part which ejects the ink. In order to make finer and more uniform patterns, much research has been focused on decreasing deflection among nozzles by operating each of the nozzles separately using a DPN (drive per nozzle) method, instead of operating a plurality of nozzles at once. The DPN (drive per nozzle) method may basically be carried out by controlling the velocity of droplets while keeping the size of the droplets constant, or by controlling the size of the droplets while keeping the velocity of the droplets constant. However, the controlling of droplets using operating signals has its limits, and if the difference between nozzles is great, it may be impossible to apply the DPN method.

FIG. 1 is a cross-sectional view of an ink-jet head according to the related art. Referring to FIG. 1, the ink-jet head consists of a piezoelectric element 60 which generates a pressure when a voltage is applied, a vibrating plate 50, a chamber 30, a nozzle 40 which ejects ink, a reservoir 10 containing the ink, and a restrictor 20 through which the ink is provided.

In the case of the ink-jet head according to the related art, even though the restrictor 20 plays a critical role in ejecting the ink, there is no means to control the restrictor 20.

The restrictor 20 is a channel for providing ink, but it also needs to act as resistance so that the pressure of the chamber 30 is delivered toward the nozzle 40 when the ink is ejected. That is, the restrictor 20 needs to have low resistance when the ink is provided and high resistance when the ink is ejected.

However, in the ink-jet head according to the related art, the restrictor 20 generally has a fixed form, maintaining the same resistance as that of the nozzle 40. Occasionally, there may be a restrictor with a different shape according to functional needs, but even then, the restrictor is of a fixed form, and incapable of resolving the problem described above.

### SUMMARY

An aspect of the invention is to provide an ink-jet head which provides improved performance, as the restrictor is designed to be capable of controlling the resistance of a fluid in the ink-jet head.

One aspect of the invention provides an ink-jet head which includes a nozzle, a chamber from which to supply ink to the nozzle, a restrictor which acts as a channel through which to supply the ink to the chamber, a vibrating plate covering one side of each of the chamber and the restrictor, a first actuator joined with the vibrating plate in correspondence to the location of the chamber, and a second actuator joined with the vibrating plate in correspondence to the location of the restrictor.

The second actuator may include a piezoelectric element.

The ink-jet head may additionally include a first power supply part which supplies power to the first actuator and a second power supply part which supplies power to the second actuator. Here, the power of the first power supply part and the power of the second power supply part may have the same frequency.

Also, the ink-jet head may further include a control part which controls the operation of the second actuator. Here, the control part may include a sensor part which senses a displacement of the second actuator and generates an input-signal corresponding to the displacement, a central processing part which receives the input-signal and generates an operating-signal corresponding to the input-signal, and an operating part which receives the operating-signal and operates the second actuator.

Another aspect of the invention provides an ink-jet head that includes a nozzle, a chamber supplying an ink to the nozzle, a restrictor as a channel supplying the ink to the chamber, a vibrating plate covering one side of the chamber and the restrictor separately, and an actuator joined with the vibrating plate in correspondence to the locations of the chamber and the restrictor.

Additional aspects and advantages of the present invention will become apparent and more readily appreciated from the following description, including the appended drawings and claims, or may be learned by practice of the invention.

### BRIEF DESCRIPTION OF THE DRAWINGS

FIG. 1 is a cross-sectional view of an ink-jet head according to prior art.

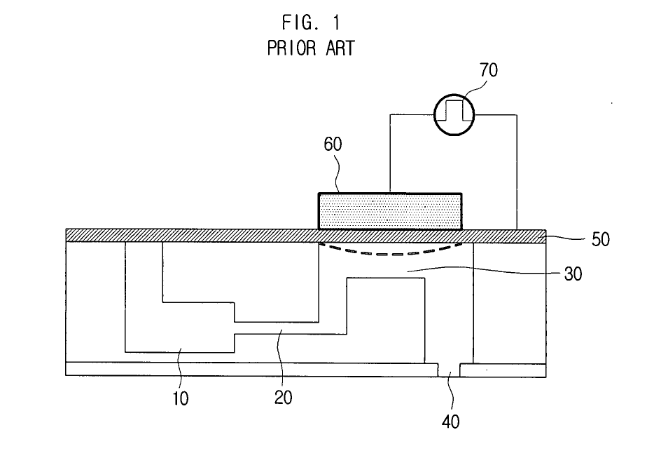

FIG. 2 is a cross-sectional view of an ink-jet head according to a first disclosed embodiment of the present invention.

FIG. 3 is a cross-sectional view illustrating a first operational state of the ink-jet head shown in FIG. 2.

FIG. 4 is a cross-sectional view illustrating a second operational state of the ink-jet head shown in FIG. 2.

FIG. 5 is a cross-sectional view of an ink-jet head according to a second disclosed embodiment of the present invention.

FIG. 6 is a cross-sectional view illustrating a first operational state of the ink-jet head shown in FIG. 5.

FIG. 7 is a cross-sectional view illustrating a second operational state of the ink-jet head shown in FIG. 5.

### DETAILED DESCRIPTION

The ink-jet head according to certain embodiments of the invention will be described below in more detail with reference to the accompanying drawings. In the description with reference to the accompanying drawings, those components are rendered the same reference number that are the same or are in correspondence regardless of the figure number, and redundant explanations are omitted.

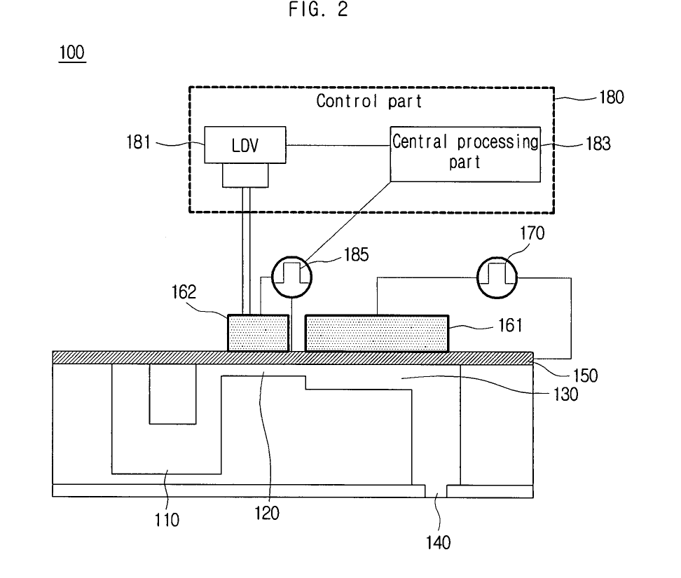

FIG. 2 is a cross-sectional view of an ink-jet head according to a first disclosed embodiment of the present invention. In FIG. 2 are illustrated a reservoir 110, a restrictor 120, a chamber 130, a nozzle 140, a vibrating plate 150, a first actuator 161, a second actuator 162, a power supply 170, a sensor part 181, a central processing part 183 and an operating part 185.

The reservoir 110 may contain ink, and provide the ink to the chamber 130 thorough the restrictor 120.

The restrictor 120 may serve as a channel that connects the chamber 130 with the reservoir 110, and provide ink to the chamber 130 from the reservoir 110. The restrictor 120 may be formed with a cross-sectional area smaller than that of the reservoir 110. Also, the restrictor 120 may control the amount of ink provided from the reservoir 110 to the chamber 130 when the vibration plate is made to vibrate by the piezoelectric element.

The restrictor 120 may be formed at the upper part of the ink-jet head so that one side of the restrictor 120 is covered by the vibrating plate 150, and the second actuator 162 may be joined with the upper surface of the vibrating plate 150 corresponding to the location of the restrictor 120.

The chamber 130 may be connected with the reservoir 110 by the restrictor 120. Moreover, the portion of the chamber 130 which is not connected with the restrictor 120 may be connected with the nozzle 140. Therefore, the chamber 130 may receive the ink from the reservoir 110 and provide the ink to the nozzle 140, whereby printing may take place.

One side of the chamber 130 may be covered by the vibrating plate 150, and the first actuator 161 may be joined with the upper surface of the vibrating plate 150 corresponding to the location of the chamber 130.

The first actuator 161 may be joined to the upper surface of the vibrating plate 150 corresponding to the chamber 130, and may generate a vibration. The first actuator 161 may include a piezoelectric element. The piezoelectric element may generate a vibration according to the voltage applied to it, and provide a pressure to the chamber 130 through the vibrating plate 150.

The nozzle 140 may be connected with the chamber 130, and may eject the ink. When a vibration generated by the first actuator 161 is supplied to the chamber 130 through the vibrating plate 150, a pressure may be supplied to the chamber 130, and the nozzle 140 may eject the ink to an object by the pressure. Through that, printing may take place.

The vibrating plate 150 may be formed at the upper portion of the chamber 130 and the restrictor 120. The vibrating plate 150 may be joined to the upper portion of the pressure and the restrictor 120 as a separate one. Also, the vibrating plate 150 may be formed by various other methods.

The vibrating plate 150 may be made of a material or structure having sufficient elasticity, as the vibrating plate 150 serves to deliver the vibration generated by the first actuator 161 to the chamber 130. For example, the vibrating plate 150 may be made of metal or ceramics.

The second actuator 162 may be joined to the upper surface of the vibrating plate 150 corresponding to the location of the restrictor 120, and generate a vibration. The second actuator 162 may include a piezoelectric element, just as the first actuator 161. The piezoelectric element may generate a vibration according to the voltage applied, and provide a pressure to the restrictor 120 through the vibrating plate 150. The second actuator 162 may be controlled by the control part 180.

The control part 180 may include a sensor part 181, a central processing part 183 and an operating part 185. The sensor part 181 may sense a displacement of the second actuator 162, and generate an input-signal corresponding to the displacement. The central processing part 183 may receive the input-signal, and generate an operating-signal corresponding to the input-signal. The operating part 185 may receive the operating-signal, and operate the second actuator 162.

The sensor part 181 may sense a vibration of the second actuator 162, namely, piezoelectric element. Then, the sensor part 181 may generate an input-signal based on the displacement of the second actuator 162, and deliver it to the central processing part 183. A LDV (Laser Doppler Velocimeter) may be used as the sensor part 181.

The central processing part 183 may receive the input-signal generated by the sensor part 181, and generate an operating-signal for operating the second actuator 162

The operating part 185 may serve to receive the operating-signal generated by the central processing part 183, and operate the second actuator 162. If the second actuator 162 includes a piezoelectric element, the operating part 185 may be a power supply 170 which provides a voltage.

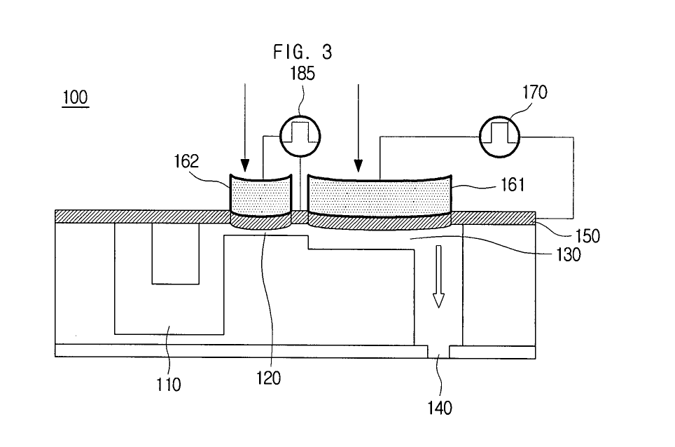

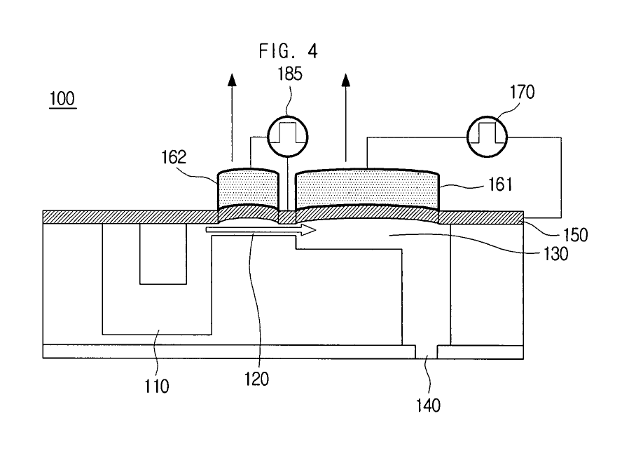

Next, referring to FIG. 3 and FIG. 4, an operation of the ink-jet head according to the first embodiment of the invention will be described below. FIG. 3 is a cross-sectional view illustrating a first operational state of the ink-jet head shown in FIG. 2, and FIG. 4 is a cross-sectional view illustrating a second operational state of the ink-jet head shown in FIG. 2.

When the first actuator 161 provides a pressure to the chamber 130 for ejecting an ink, the pressure may be provided toward not only the nozzle 140 but also the restrictor 120. So, some ink may run back to the restrictor 120. The running back of the ink may cause low operating efficiency of the ink-jet head.

To prevent this, when the first actuator 161 provides a pressure to the chamber 130, the cross section of the restrictor 120 may be decreased by the pressure provided to the restrictor 120 so that the channel resistance of the restrictor 120 may be increased. By increasing the channel resistance of the restrictor 120, the channel resistance of the nozzle 140 may be decreased in relation to the channel resistance of the restrictor 120, and the running back of the ink toward the restrictor 120 may be suppressed. Such operation may be observed in FIG. 3.

When the first actuator 161 decreases the pressure of the chamber 130, that is, when the first actuator 161 vibrates toward the upper direction of the ink-jet head, the inflow of the ink toward the chamber 130 may be proceeded with more smoothly.

For this, when the first actuator 161 decreases the pressure of the chamber 130, the second actuator 162 may decrease the pressure of the restrictor 120, that is, the second restrictor 120 may vibrate toward the upper direction of the inkjet head. As a result, the cross section of the restrictor 120 may be enlarged, and the channel resistance of the restrictor 120 may be decreased. As the channel resistance of the restrictor 120 is decreased, the flow of ink towards the chamber 130 may be proceeded with more smoothly. Such operation may be observed in FIG. 4.

As described above, the operation of the first actuator 161 and the second actuator 162 may be synchronized for a smoother operation of the ink-jet head according to this embodiment.

For example, in the case of each of the first actuator 161 and the second actuator 162 including a piezoelectric element, the synchronization may be carried out by supplying the same voltage to the first actuator 161 and the second actuator 162.

Conversely, in order to increase efficiency in controlling the channel resistance of the restrictor 120, the voltage supplied to the second actuator 162 and the voltage supplied to the first actuator 161 may have different magnitudes. In other words, the operation of the second actuator 162 may be controlled separately from the operation of the first actuator 161, while observing the operation of the ink-jet head according to this embodiment in real time. For this, a control part may be arranged which controls the second actuator 162 separately.

The control part 180 may include a sensor part 181 which senses the vibrating states of the second actuator 162, i.e. the displacement, and generates an input-signal corresponding to the displacement, a central processing part 183 which receives the input-signal and generates an operating-signal corresponding to the input-signal, and an operating part 185 which receives the operating-signal and operates the second actuator 162.

For example, if the second actuator 162 includes a piezoelectric element, the sensor part 181 may sense the vibration of the piezoelectric element in real time. That is, the sensor part 181 may sense the displacement of the second actuator 162 vibrated by the operating part 185. The sensor part 181 may generate an input-signal based on the displacement of the second actuator 162, and deliver the input-signal to the central processing part 183.

The central processing part 183 may receive the input-signal generated by the sensor part 181, and generate an operating-signal to realize the operation of the second actuator 162 intended by the user.

The operating part 185 may receive an operating-signal generated by the central processing part 183, and provide a voltage corresponding to the operating-signal. Then, the piezoelectric element may be vibrated as intended by the user.

With the control part 180, the channel resistance of the restrictor 120 may be controlled separately, and an ink-jet head according to this embodiment may be operated with greater efficiency.

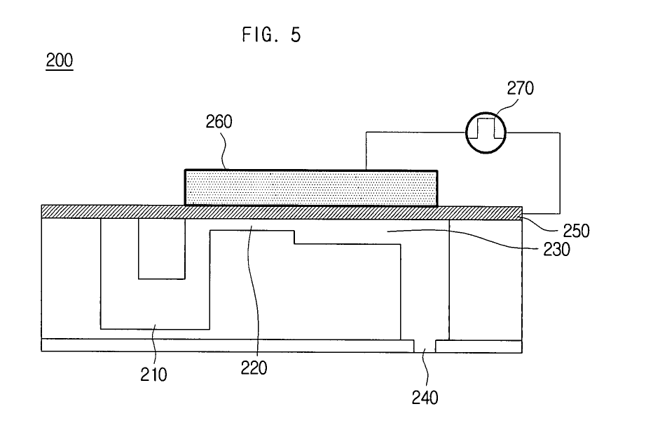

FIG. 5 is a cross-sectional view of an ink-jet head according to a second disclosed embodiment of the present invention. In FIG. 5 are illustrated a reservoir 210, a restrictor 220, a chamber 230, a nozzle 240, a vibrating plate 250, an actuator 260 and a power supply 270.

An ink-jet head 200 according to this embodiment may include one actuator 260 joined with the vibrating plate 250 corresponding to the locations of the chamber 230 and the restrictor 220 for supplying pressure to the chamber 230 and the restrictor 220. This embodiment thus differs from the first disclosed embodiment of the invention which includes the first actuator 161 providing pressure to the chamber 130 and the second actuator 162 providing pressure to the restrictor 120.

As described in the first disclosed embodiment, the operation of the first actuator 161 and the second actuator 162 may be synchronized for a smoother operation of the ink-jet head according to this embodiment. For simplifying the operation structurally, in this embodiment, one actuator 260 may replace the first actuator 161 and the second actuator 162, with the actuator 260 joined to the vibrating plate 250 in correspondence to the locations of the chamber 230 and the restrictor 220.

With the structure described above, the actuator 260 may be operated by one power supply 270. So, there is no need to have multiple power supplies for operating each one of the first actuator and the second actuator of the first disclosed embodiment according to the invention.

In this embodiment, the channel resistance of the restrictor 220 may not be controlled as in the first disclosed embodiment of the invention. However, the embodiment displays an attribute quite distinguished from that of the first disclosed embodiment, in that the pressure supplied to the chamber 230 and the restrictor 220 may be synchronized more easily.

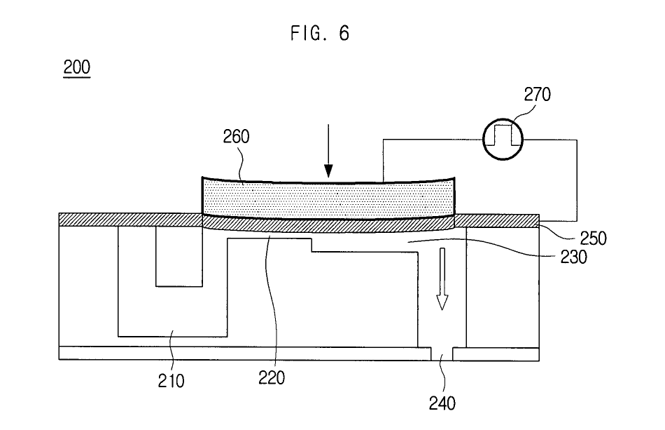

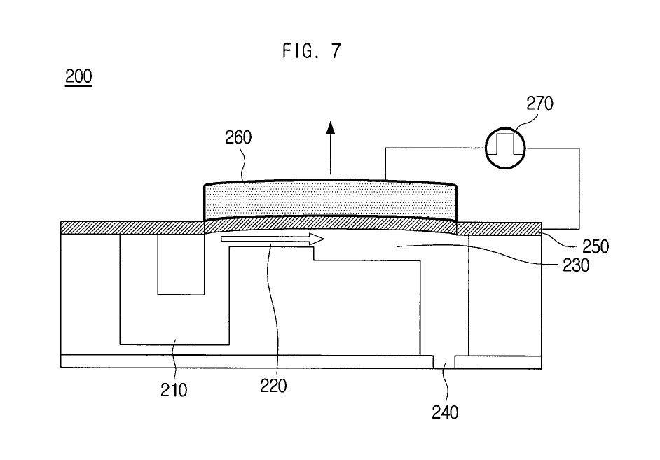

Next, the operation of the ink-jet head 200 according to the second embodiment of the invention is described below referring to FIGS. 6 and 7. FIG. 6 is a cross-sectional view illustrating a first operational state of the ink-jet head shown in FIG. 5, and FIG. 7 is a cross-sectional view illustrating a second operational state of the ink-jet head shown in FIG. 5.

When the actuator 260 vibrates toward the lower side of the ink-jet head (see FIG. 6), a pressure may be delivered to the chamber 230 and the ink may be ejected through the nozzle 240. At this time, a pressure may be delivered to the restrictor 220 by the actuator 260, and the cross section of the restrictor 220 may be decreased, whereby the channel resistance of the restrictor 220 may be increased. By increasing the channel resistance of the restrictor 220, the channel resistance of the nozzle 240 may be decreased relative to the channel resistance of the restrictor 220, and the flowing of the ink toward the restrictor 220 may be prevented. Such operation is observed in FIG. 6.

When the actuator 260 decreases the pressure of the chamber 230 so that the ink flows to the chamber 230 (see FIG. 7), that is, when the actuator 260 vibrates toward the upper side of the ink-jet head, the cross section of the restrictor 220 may be enlarged and the channel resistance of the restrictor 220 may be decreased. By decreasing the channel resistance of the restrictor 220, the inflow of the ink to the chamber 230 may be carried out more smoothly.

According to certain embodiments of the present invention as set forth above, by allowing the control of the channel resistance of the restrictor, the ability to control droplets can be improved.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. An ink-jet head comprising:
a nozzle;
a chamber supplying an ink to the nozzle;
a restrictor as a channel supplying the ink to the chamber;
a vibrating plate covering one side of each of the chamber and the restrictor;
a first actuator joined with the vibrating plate in correspondence to a location of the chamber; and
a second actuator joined with the vibrating plate in correspondence to a location of the restrictor.

2. The ink-jet head of claim 1, wherein the second actuator comprises a piezoelectric element.

3. The ink-jet head of claim 1, further comprising
a first power supply part supplying power to the first actuator; and
a second power supply part supplying power to the second actuator,
wherein the power of the first power supply part and the power of the second power supply part have the same frequency.

4. The ink-jet head of claim 1, further comprising a control part controlling an operation of the second actuator.

5. The ink-jet head of claim 4, wherein the control part comprises
a sensor part sensing a displacement of the second actuator and generating an input-signal corresponding to the displacement;
a central processing part receiving the input-signal and generating an operating-signal corresponding to the input-signal;
an operating part receiving the operating-signal and operating the second actuator.

6. An ink-jet head comprising:
a nozzle;
a chamber supplying an ink to the nozzle;
a restrictor as a channel supplying the ink to the chamber;
a vibrating plate covering one side of each of the chamber and the restrictor; and
an actuator joined with the vibrating plate in correspondence to locations of the chamber and the restrictor.
